(19) United States
(12) Patent Application Publication
(10) Pub. No.: US 2010/0106867 A1
(43) Pub. Date: Apr. 29, 2010

(54) REMOTE CONTROL DEVICE COMMUNICATION THROUGH TRANSLATION INTO HID PACKETS

(75) Inventors: Sudha R. Ghorakavi, Cypress, TX (US); Loren S. Dunn, Houston, TX (US)

Correspondence Address: HEWLETT-PACKARD COMPANY;Intellectual Property Administration, 3404 E. Harmony Road, Mail Stop 35, FORT COLLINS, CO, 80528, US

(73) Assignee: Hewlett-Packard Development Company, L.P., Fort Collins, CO (US)

(21) Appl. No.: 12/256,922

(22) Filed: Oct. 23, 2008

(51) Int. Cl. G06F 13/00

(52) U.S. Cl. 710/33

(57) ABSTRACT

Communication between a Human Interface Device (HID) protocol capable computing device and an HID incapable remote control device is enabled by generating an operating system interface event based on a wirelessly received command from the remote control device at the BIOS of the computing device, forwarding the generated event to a control software service; determining a unique action identifier associated with the received command based on the generated event at the control software service, and forwarding one or more HID packets based on the action identifier to an HID driver such that the received command is interpreted for processing by an application on the computing device.

### BACKGROUND

Many computing and programmable systems feature a remote control device such as a keyboard, a mouse, a hand-held button device, so as to increase the convenience, flexibility, and comfort of a user. In conventional systems, each remote control device typically has its narrowly defined communication protocol. For example, signals transmitted by a mouse to a computer are interpreted in a specific way associated with mouse type device only. Signals transmitted by a keyboard use a separate protocol allowing the operating system of the computing device to interpret each received signal as a key input.

Modern computing systems include an advanced communication method between remote control devices and host computing devices through Human Interface Device (HID) protocol. In HID protocol, HID devices deliver self describing packages containing a variety of data types and formats. An HID driver on the host computing device parses the data and enables dynamic association of the data Input/Output (I/O) with application functionality.

To enable interoperation of remote control system devices (e.g. remote control device 2) that do not possess HID capability with host computing systems (e.g. notebook computer 6) employing HID protocol, an external wireless transceiver (e.g. infrared transceiver 4) is commonly used. The external wireless transceiver (also referred to as “beanbag”) receives infrared command input from the remote control device 2, converts the commands to discernable HID packet output, and then relays the HID packets to the host computing device 6 for processing by the operating system or applications executed by the operating system.

### BRIEF DESCRIPTION OF THE FIGURES

Embodiments are described in detail below with reference to the attached figures, wherein:

FIG. 1 is an example system illustrating a notebook computer host, a remote control device, and a beanbag interface facilitating intercommunication between the remote control device and the notebook computer;

FIG. 2 is a system including a notebook computer host and remote control device directly intercommunicating, in accordance with an example embodiment;

FIG. 3 is an elevation view of a hand-held button function remote control device, in accordance with another example embodiment;

FIG. 4 is a schematic view of a system particularly illustrating the inter-modular architecture of the host computing device, in accordance with a further embodiment;

FIG. 5 is a schematic view of the system shown in FIG. 4, further representing the intra-modular architecture of the host, in accordance with an embodiment, and alternatively, a prior art beanbag flow comparison; and

FIG. 6 is a flow diagram of a method of communicating HID packets between a remote control device and a host, in accordance with yet another embodiment.

### DETAILED DESCRIPTION

Embodiments are directed to methods of communicating commands between a remote control device and a host computing device using Human Interface Device (HID) packets. Pre-existing host communication ports and modified operating system/platform modules may be used to convert remote device commands into discernable HID packets. As a result, a system becomes readily useful for providing remote control functionality at reduced implementation and operating costs. According to one embodiment, a host computing device may store and execute a Basic Input Output System (BIOS) module configured to translate commands associated with selected remote device functional input elements such as buttons in conjunction with a control software service. Operating system interface events such as Windows Management Instrumentation (WMI) events may be generated based on received commands and provided to control software service for generation of HID compatible packets.

According to one embodiment, communication between the BIOS of a host computing device and a control software service is enabled such that operating system interface events generated based on received remote control device commands are sent by the BIOS to the control software service. The control software service may determine an action identifier associated with the received command by querying the BIOS based on the received operating system interface event. The action identifier may be a unique number agreed between the BIOS and the control software service. The control software service may then translate the action identifier to HID packet(s) and forward the packet(s) to an HID driver of the operating system such that the received remote control device command can be executed in coordination with an application executed by the operating system.

Thus, in system 10 of FIG. 2 according to one embodiment, an external wireless transceiver is no longer needed to facilitate communication between remote control device 12 incapable of transmitting HID packet(s) and host computer 14 employing HID protocol. While embodiments are described using host computers as example, the approaches described herein may be implemented in other computing devices such as cell phones, PDA's, servers, entertainment consoles, multi-processor systems, microprocessor-based systems, network PCs, minicomputers, mainframe computers, and the like, without departing from a scope and spirit of the present disclosure.

In the HID protocol architecture, a remote control device 12 defines its data packets and presents an “HID descriptor” to the host computer 14. The HID descriptor is a hardcoded array of bytes that describe the data packets of the device. This information may contain the number of supported packets, the size of the packets, and the function/purpose of each byte and bit in the packet. For example, a keyboard with a calculator program button can tell the host that the pressed/released state of the button is stored as the second bit in the sixth byte in data packet number four.

In a report mode, the host, in an effort to fully communicate with the device, typically retrieves and analyzes the HID descriptor from the device, which “reports” it to the host. In a boot mode, a defined list of devices, or only a portion of the functionality from these devices, are pre-loaded and recognized by the host. For example, in boot mode only the core keys of a keyboard may be supported, while advanced functionality, such as the Calculator and Logoff keys, are not. With respect to a mouse, only the X-axis, Y-axis, wheel, and the first three buttons may be recognized, while additional features are not.

As discussed above, a system 10 according to embodiments enables a non-HID compatible remote control device 12 to communicate with the host computer 14 through the use of modified modules already present upon an otherwise conventional host computer. Thus, embodiments are advantageously adapted for use with an existing host by simply retrofitting (i.e., programmably reconfiguring) executable modules, code, and/or instruction stored thereupon, as further described herein.

In a system according to embodiments, the host computing device and the remote control device may communicate through a variety of wireless means including, but not limited to, optical communications (e.g. infrared), Radio Frequency (RF) communications (e.g. Bluetooth, IEEE 802.15.4, etc.), and comparable means. The communications may be facilitated for a variety of host computing devices and remote control devices such as the example ones discussed herein, but also others. Moreover, software and hardware modules described throughout this disclosure for performing specific tasks may be arranged differently within the overall system architecture, certain tasks performed by more than one module or combined to be performed by a single module.

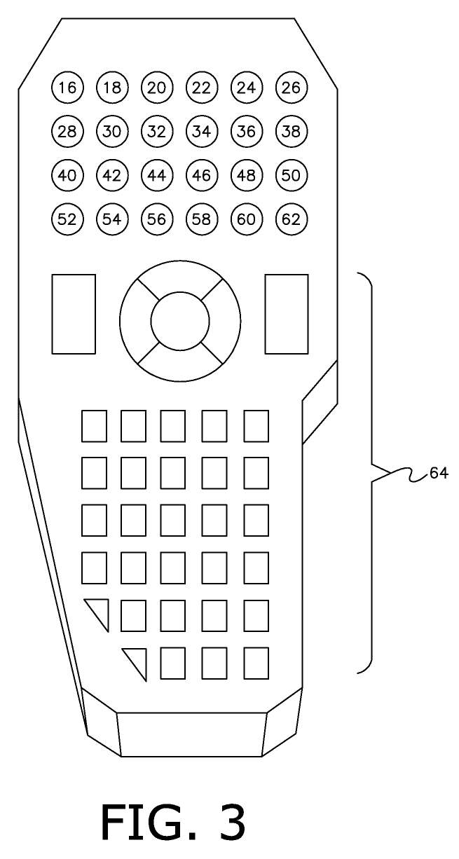

FIG. 3 illustrates a remote control device 64 with a plurality of functional input elements (e.g., buttons, wheel, keys, etc.). Each element of the remote control device 64 is configured to wirelessly transmit a separate command signal to the host computing device. For example, the remote control device 12 may send infrared (IR) commands to a host IR port 14a as shown in FIG. 2.

It should be noted, that in a system according to one embodiment, a portion of the device elements may be enabled to communicate through translation into HID packets, while a remainder set may be communicatively coupled to the host through alternate means (e.g., Hot Start, Keyboard Equivalent, Scan Code, etc.). For example, conversion may be provided for alpha-numerical buttons 0-9, “*,” and “#,” and with media control (e.g., Play, Pause, and Record (as shown in Table 1 below)) buttons, while other broader functioning buttons, such as the Power, DVD, Music, and Video buttons are handled as Hot Start button events.

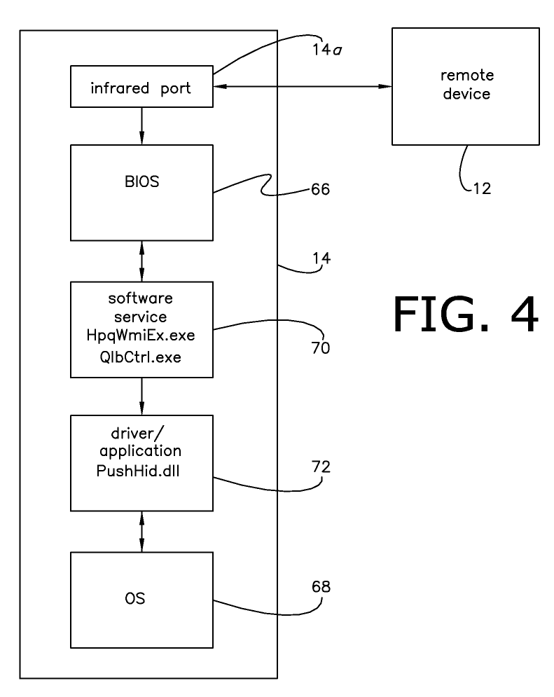

FIG. 4 illustrates main components in the architecture of a system according to one embodiment. A host computing device 14 has stored thereupon for execution at start-up a BIOS 66, a supported operating system (OS) 68, a control software service 70 for translating received remote control device commands into HID packets, and a driver/application 72 for interpreting received HID packets. Quick Launch Button Software (QLBS) service by Hewlett-Packard Company of Palo Alto, Calif. is an example of control software services.

A function of the BIOS module 66 is to identify and initiate component hardware, such as remote control device 12. This prepares the host computing device 14, so that software programs such as applications stored on various media can load, execute, and assume control of the PC in a process known as booting. According to one embodiment, the BIOS 66 may be modified to support the conversion of device commands to specified WMI events. According to another embodiment, an initial determination may be made whether BIOS 66 is equipped to perform the conversion and the IR port 14a selectively turned on or off.

In the illustrated embodiment of FIG. 4, the control software service 70 is recognized by the OS 68 as an IR control, and may include a registry change so as to allow triple-tap text entry. For example, to enable triple-tap text entry via the numeric keypad on the remote device 12, the following registry entry may be entered with the correct PNP ID for the infrared port 14a:

HKEY_LOCAL_MACHINE\SOFTWARE\\Windows\CurrentVersion\
MediaCenter\Remote Controls]
“HID\\VID_xxx&PID_yyyy “=””.

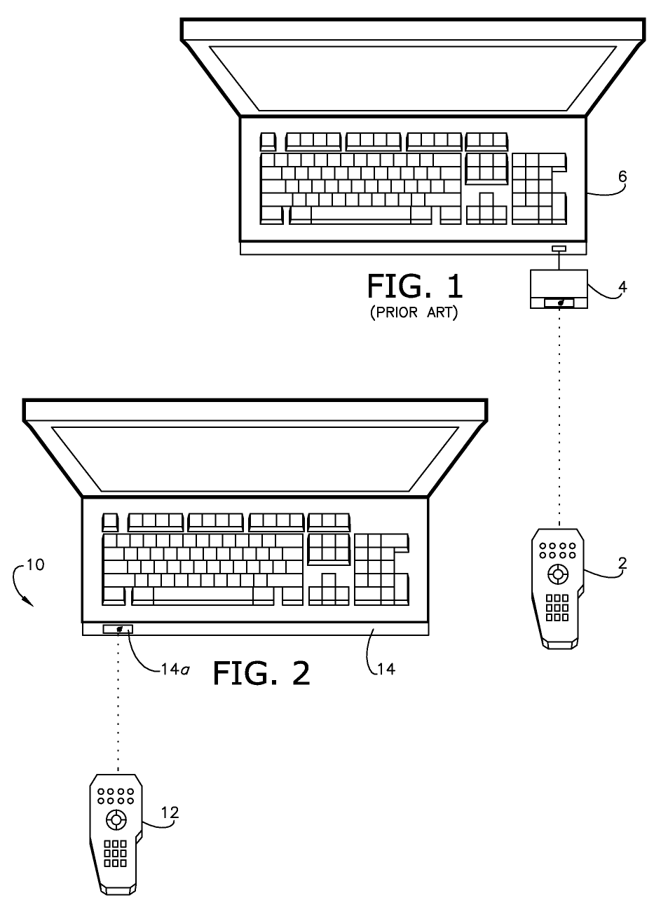

The control software service 70 may include an executable file (e.g. QlbCtrl.exe), to determine action identifiers with respect to the afore-mentioned select buttons. The control software service may be initially configured to detect the presence of an external transceiver (e.g. transceiver 4 of FIG. 1), and automatically activate conversion when the external transceiver is not detected. The control software service may be modified to recognize new WMI identifiers from the remote control device 12 through the BIOS 66. According to some embodiments, control software service 70 may utilize another executable module to access WMI interface uniformly across various implementations. For example, HpqWmiEx.exe, may be used to access the WMI subsystem.

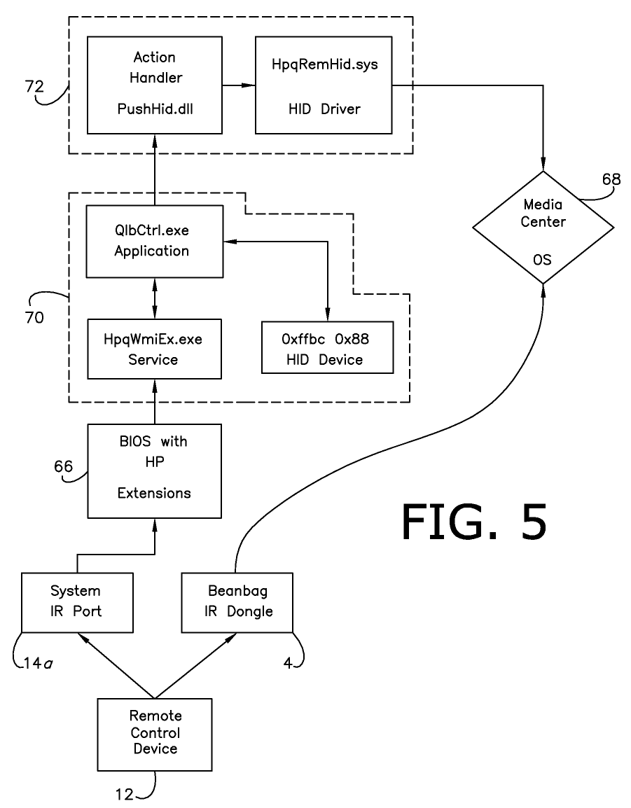

The control software service 70 may also utilize an action handler to send the HID data to the application/driver 72, as shown in FIG. 5. For example, action dll, PushHid.dll may call the HpqRemHid.sys driver 72. More particularly, the control software service 70 may send an appropriate action identifier (e.g., the WMI identifier) to the dll, and PushHid.dll may convert it to HID data, including the data size, HID report id, and HID report data, and send it to the HpqRemHid.sys driver 72 using an I/O control call. Thus, the PushHid.dll module may contain the WMI identifier to HID data conversion, and share the HID report descriptor, which resides in the registry, with HpqRemHid.sys. The HpqRemHid.sys driver 72 may be configured to read the HID report descriptor from the registry so that the driver can automatically change when the descriptor is changed.

Thus, an operation according to embodiments may include receiving indication of selection of a button on a remote control device 12 at IR port 14a connected to a host computing device 14, converting the received command (event) to a WMI event using BIOS 66, sending the WMI event to the control software service 70, determining an action identifier by querying BIOS 66, and returning the unique action identifier.

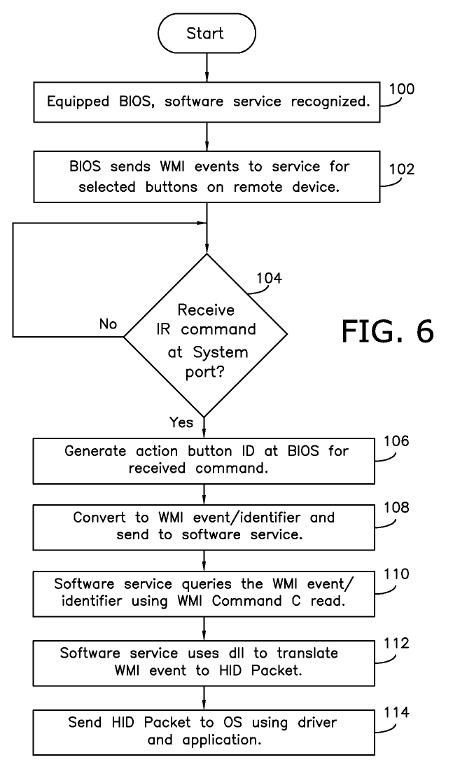

FIG. 6 further presents a method according to embodiments, and includes initial step 100, where conversion capable BIOS 66 and control software service 70 are autonomously recognized and/or turned on. At step 102, a non-exclusive set of WMI events/identifiers are sent to the control software service 70 for supported remote device buttons. At step 104, it is determined whether a button command has been received through the IR system port 14a of the host computing device 14.

When a command is received, the method continues to step 106, where a button action identifier, unique to the BIOS 66 and control software service 70, is generated by the BIOS 66; otherwise, the method may loop back to step 104. At step 108, a WMI event/identifier and sent to the control software service 70.

At step 110, the control software service 70 queries the list of WMI events/identifiers so as to determine a matching action identifier. At step 112, the service 70 calls an action dll to translate the action identifier into HID packet format. Finally, at step 114 the matching HID packet is sent to the operating system 68 via an application and driver.

The operations included in the flowchart of FIG. 6 are for illustration purposes. A method according to embodiments may be implemented by similar processes with fewer or additional steps, as well as in different order of operations using the principles described herein. While the embodiments are described in the general context of program modules that execute in conjunction with hardware or an application program that runs on an operating system on a personal computer, those skilled in the art will recognize that aspects may also be implemented in combination with other program modules. Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

The following table 1 provides an exemplary list of remote device action buttons, matching WMI events/identifiers, and HID packet information, in accordance with a preferred embodiment of the invention, with the understanding that the remainder set of non-converted action buttons is not presented.

TABLE 1

| | | | PushHid.dll sends HID Report to |
|---|---|---|---|
| Name | Identifier | Programmable | the HpqRemHid.sys driver |
| 0 | 8561 | No | QLB outputs HID Hid Usage |
| | | | 0x27 (HID Page 0x07) |
| 1 | 8562 | No | QLB outputs HID Hid Usage |
| | | | 0x1e (HID Page 0x07) |
| 2 | 8563 | No | QLB outputs HID Hid Usage |
| | | | 0x1f (HID Page 0x07) |
| 3 | 8564 | No | QLB outputs HID Hid Usage |
| | | | 0x20 (HID Page 0x07) |
| 4 | 8565 | No | QLB outputs HID Hid Usage |
| | | | 0x21 (HID Page 0x07) |
| 5 | 8566 | No | QLB outputs HID Hid Usage |
| | | | 0x22 (HID Page 0x07) |
| 6 | 8567 | No | QLB outputs HID Hid Usage |
| | | | 0x23 (HID Page 0x07) |
| 7 | 8568 | No | QLB outputs HID Hid Usage |
| | | | 0x24 (HID Page 0x07) |
| 8 | 8569 | No | QLB outputs HID Hid Usage |
| | | | 0x25 (HID Page 0x07) |
| 9 | 8570 | No | QLB outputs HID Hid Usage |
| | | | 0x26 (HID Page 0x07) |
| EHome | 8560 | No | QLB outputs Hid Usage 0x0d |
| | | | (HID Page 0xffbc) |
| Play | 8571 | No | QLB output Hid Usage 0xb0 |
| (Rover) | | | (HID Page 0x0c) |
| Record | 8572 | No | QLB outputs hid usage 0xb2 |
| | | | (HID Page 0x0c) |
| Pause | 8573 | No | QLB outputs hid usage 0xb1 |
| | | | (Hid page 0x0c) |
| # (Rover) | 8574 | No | Qlb outputs hid usage 0x20 (hid |
| | | | page 0x07) |
| * (Rover) | 8576 | No | Qlb outputs hid usage 0x25 (hid |
| | | | page 0x07) |
| Live TV | 8577 | No | Qlb outputs hid usage 0x25 (hid |
| | | | page 0xffbc) |
| Aspect | 8578 | No | Qlb outputs hid usage 0x27 (hid |
| Zoom | | | page 0xffbc) |
| (Rover) | | | |
| Teletext | 8579 | No | Qlb outputs hid usage 0x5a (hid |
| On/Off | | | page 0xffbc) |
| Teletext | 8580 | No | Qlb outputs hid usage 0x5b (hid |
| Red | | | page 0xffbc) |
| Teletext | 8575 | No | Qlb outputs hid usage 0x5c (hid |
| Green | | | page 0xffbc) |
| Teletext | 8581 | No | Qlb outputs hid usage 0x5d (hid |
| Yellow | | | page 0xffbc) |
| Teletext | 8582 | No | Qlb outputs hid usage 0x5e (hid |
| Blue | | | page 0xffbc) |
| Snapshot | 8583 | No | Qlb outputs hid usage 0x6f (hid |
| (Rover) | | | page 0xffbc) |

When an external transceiver is present, however, the system may be further configured to provide input filtering for one or more HID devices to support a specific function. For example, the 0xffbc 0x88 HID device may be filtered, where QlbCtrl.exe is configured to catch HID reports deemed interesting and perform a specific action as a result thereof. That is to say, this device is used to intercept HID command coming from the external transceiver. An automatic filtering mechanism capable of intercepting HID commands may be used to enable performance of an ancillary function associated with the intercepted HID command such as launching an application associated with the intercepted command (activation of a video player application), adjusting a host computing device user interface parameter associated with the intercepted command (setting a backlighting of a display application or audio level of an audio player application), and comparable functions. An exemplary list of HID usages (e.g., filter buttons) that QLBCtrl.exe may be interested in is presented in the following table.

TABLE 2

| | | | | | | Final |
|---|---|---|---|---|---|---|
| | | HID | HID | HID | HID | Output |
| | | TLC | TLC | Button | Button | (QLB |
| Key | Extensibility # | Page | Usage | Page | Usage | action) |
| Live TV | Ext7 | 0xffbc | 0x88 | 0xffbc | 0x39 | QLB |
| | | | | | | launches |
| | | | | | | QP-TV if |
| | | | | | | MCE isn't |
| | | | | | | active |
| Entertainment | Ext8 | 0xffbc | 0x88 | 0xffbc | 0x3a | KBC dims |
| Mode (dim LEDs) | | | | | | LEDs |
| Toggle Monitor | Ext10 | 0xffbc | 0x88 | 0xffbc | 0x81 | KBC fn + F4 |

The present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device or media. As such, it is appreciated that the host computing device 14 and remote control device 12 are equipped with and operate suitable processing, storage, and communicative capabilities to affect the intended steps of a method according to embodiments.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least partially on a computing device for communicating with a remote control device, the method comprising:
wirelessly receiving a command generated by the remote control device;
generating an operating system interface event based on the received command at a Basic Input Output System (BIOS) of the computing device;
forwarding the generated event to a control software service;
determining a unique action identifier associated with the received command based on the received event at the control software service; and
forwarding at least one Human Interface Device (HID) packet based on the action identifier to an HID driver such that the received command is interpreted for processing by an application on the computing device.

2. The method of claim 1, wherein determining the unique action identifier includes:
querying the BIOS based on the received event at the control software service; and
receiving the unique action identifier from the BIOS.

3. The method of claim 1, wherein forwarding the at least one HID packet includes:
translating the action identifier to the at least one HID packet through an action dynamic library link (dll) module; and
sending the at least one HID packet to the HID driver.

4. The method of claim 1, further comprising:
determining if the BIOS is capable of generating the operating system interface event and the unique action identifier; and if not
configuring the BIOS to generate operating system interface events and unique action identifiers responsive to received commands from the remote control device.

5. The method of claim 1, wherein the operating system interface is a Windows Management Instrumentation (WMI) interface.

6. A computing device capable of communicating wirelessly with a remote control device utilizing HID protocol regardless of a capability of the remote control device to generate HID compatible commands, the computing device comprising:
a wireless communication port;
a memory; and
a processor coupled to the memory, the processor configured to execute:
a BIOS capable of generating an operating system interface event based on a non-HID compatible command received through the wireless communication port, forwarding the event to a control software service, receiving a query from the control software service based on the event, and sending a unique action identifier associated with the received command to the control software service; and
the control software service capable of querying the BIOS responsive to receiving the operating system interface event, receiving the unique action identifier, translating the action identifier to at least one HID packet, and forwarding the at least one HID packet to an HID driver for processing by an application on the computing device.

7. The computing device of claim 6, wherein the control software service is further capable of:
determining whether the BIOS is capable of generating operating system interface events based on a non-HID compatible commands; and
selectively activating the wireless communication port.

8. The computing device of claim 6, wherein the control software service is further capable of:
determining whether an external transceiver capable of translating non-HID commands to HID packets is present; and
automatically activating operating system interface event generation and action identifier transmission operations if the external transceiver is not present.

9. The computing device of claim 6, wherein a first portion of received commands are non-HID compatible commands and a second portion of received commands are HID compatible commands, and wherein the BIOS and the control software service are configured such that the first portion of received commands are processed through generation of operating system interface events and translation into HID packets using unique action identifiers, and the second portion of the received commands are forwarded directly to the HID driver.

10. The computing device of claim 6, wherein the computing device and the remote control device communicate through one of the following: an infrared communication and a short range Radio Frequency (RF) communication.

11. A system for enabling short range communication utilizing HID packets, the system comprising:
a remote control device including a plurality of input elements, wherein at least a portion of the elements is configured to generate a non-HID compliant device command; and
a host computing device including:
a modified BIOS configured to:
receive a command from the remote control device through a wireless communication port;
if the command is HID-compatible, forward to an HID driver;
else, generate and forward an operating system interface event to a control software service; and
send a unique action identifier associated with the received command to the control software service responsive to a query from the control software service; and
the control software service configured to:
query the BIOS responsive to receiving the operating system interface event;
translate the action identifier to at least one HID packet based on the unique action identifier using an action dll; and
forward the at least one HID packet to the HID driver for processing by an application on the computing device.

12. The system of claim 11, wherein the control software service is further configured to:
determine whether an external transceiver capable of translating non-HID commands to HID packets is present; and
if the transceiver is present, activate an automatic filtering mechanism capable of intercepting HID commands from the external transceiver and enable performance of an ancillary function associated with the intercepted HID command.

13. The system of claim 12, wherein the ancillary command includes one of: launching an application associated with the intercepted command and adjusting a host computing device user interface parameter associated with the intercepted command.

14. The system of claim 11, wherein the control software service includes a first module for querying and receiving action identifiers from the BIOS and a second module for accessing the operating system interface.

15. The system of claim 11, wherein the action identifier is a numeric value unique to each distinct command from the remote control device agreed between the BIOS and the control software service.
